(19) United States
(12) Patent Application Publication
(10) Pub. No.: US 2026/0113092 A1
(43) Pub. Date: Apr. 23, 2026

(54) BEAM FOCUSING

(71) Applicant: InterDigital Patent Holdings, Inc., Wilmington, DE (US)

(72) Inventors: Allan Tsai, Boonton, NJ (US); Patrick Svedman, Stockholm (SE); Guodong Zhang, Woodbury, NY (US); Kyle Jung-Lin Pan, Saint James, NY (US); Arman Shojaeifard, London (GB); Omid Saatlou, Montreal (CA)

(21) Appl. No.: 19/146,025

(22) PCT Filed: Jan. 3, 2024
(86) PCT No.: PCT/US2024/010155

§ 371 Date: Jul. 7, 2025

Related U.S. Application Data
(60) Provisional application No. 63/437,478, filed on Jan. 6, 2023.

(51) Int. Cl. H04B 7/06

(52) U.S. Cl. CPC H04B 7/0626; H04B 7/0617

(57) ABSTRACT

Described herein are systems, methods, and instrumentalities associated with c under near field conditions. Channel station information (CSI) reporting under these conditions may be performed based on partial CSIs associated with respective parts of an antenna array. CSI reference signals (CSI-RSs) for the CSI reporting may be bundled and an indication may be provided to a wireless transmit/receive unit (WTRU) to indicate whether the WTRU is under the near field conditions.

### CROSS-REFERENCE TO RELATED APPLICATIONS

The present application claims the benefit of U.S. Provisional Patent Application No. 63/437,478 filed Jan. 6, 2023, which is incorporated herein by reference in its entirety.

### TECHNICAL FIELD

The present disclosure is generally directed to beamfocusing. More particularly, the present disclosure relates methods, architectures, apparatuses and systems for near field beamfocusing and for CSI acquisition methods for beamfocusing operating in the near field.

### BACKGROUND

If an antenna array or metasurface dimension is increased and/or a link distance is reduced, a near field condition may be considered to have occurred. In this case, conventional beamforming for a far field may not ensure array gains for the near field condition and beamfocusing (or beam focusing) may be used to enhance the performance of a communication device.

### SUMMARY

Described herein are systems, methods, and instrumentalities associated with beamfocusing under near field conditions. Channel station information (CSI) reporting under these conditions may be performed based on partial CSIs associated with respective parts of an antenna array. CSI reference signals (CSI-RSs) for the CSI reporting may be bundled and an indication may be provided to a wireless transmit/receive unit (WTRU) to indicate whether the WTRU is under the near field conditions.

The WTRU may include a processor configured to receive configuration information from a base station regarding a CSI report group, where the CSI report group may include multiple CSI reports. A first CSI report of the CSI report group may be associated with a first part of an antenna array and a second CSI report of the CSI report group may be associated with a second part of the antenna array. The processor may be further configured to receive a first CSI-RS associated with the first part of the antenna array and a second CSI-RS associated with the second part of the antenna array. The first CSI-RS and the second CSI-RS may be bundled together, and the processor may determine, based on the first CSI-RS, first channel state information associated with the first part of the antenna array and further determine, based on the second CSI-RS, second channel state information associated with the second part of the antenna array. The processor may then generate a CSI report for the antenna array based at least on the first channel state information and the second channel state information.

In examples, the processor may be further configured to compress at least one of the first channel state information or the second channel state information. The processor may be further configured to receive a request from the base station for transmitting an SRS, for example, to assist the CSI reporting operations. The processor may be further configured to receive an indication from the base station regarding whether the WTRU is in a near field or a far field.

In an embodiment, a method implemented in a wireless transmit/receive unit, WTRU, may comprise a step of receiving by the WTRU, from a network node, configuration information, wherein the configuration information comprises a plurality of beamforming indicators indicating far field beamforming or near field beamfocusing, wherein the plurality of beamforming indicators is associated with receiver parameters, and wherein the beamforming indicators indicate distance parameter information. The method may comprise a step of determining a beamforming among the far field beamforming and the near field beamfocusing, based on one beamforming indicator of the plurality of beamforming indicators. The method may further comprise a step of determining receiver parameters of the WTRU based on the determined beamforming; and a step of receiving communication from a transmission/reception point TRP using the determined receiver parameters of the WTRU. The method may comprise a step of transmitting communication to the TRP using the determined receiver parameters of the WTRU.

The determined receiver parameters may comprise angular spread of the beamforming. The method may comprise the step of determining far field beamforming on condition that the distance parameter exceeds a distance threshold. Determining near field beamfocusing may be on condition that the distance parameter does not exceed a distance threshold. The one beamforming indicator may comprise information on Rayleigh distance, and the method may comprise a step of determining the distance threshold based on the Rayleigh distance; and on condition that the distance parameter does not exceed the distance threshold, determining near field beamfocusing. The distance threshold may be received from the TRP. The method may comprise a step of receiving downlink control information comprising an indication of the one beamforming indicator or a step of receiving an indication of the one beamforming indicator in a Medium Access Control (MAC) control element or a step of receiving from the TRP, the one beamforming indicator of the plurality of beamforming indicators.

In an embodiment, a wireless transmit/receive unit, WTRU, comprising a processor, a transceiver unit and a storage unit, may be configured to receive from a network node, configuration information, wherein the configuration information comprises a plurality of beamforming indicators indicating far field beamforming or near field beamfocusing, wherein the plurality of beamforming indicators is associated with receiver parameters, and wherein the beamforming indicators indicate distance parameter information. The WTRU may be configured to determine, a beamforming among the far field beamforming and the near field beamfocusing; based on one beamforming indicator of the plurality of beamforming indicators. The WTRU may be configured to determine receiver parameters of the WTRU based on the determined beamforming; and may be further configured to receive communication from a transmission/reception point TRP using the determined receiver parameters of the WTRU. The WTRU may be configured to transmit communication to the TRP using the determined receiver parameters of the WTRU.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example of a large array/surface size transmission under a line of sight (LoS) scenario.

FIG. 3 is a diagram illustrating near field assumptions and far field assumptions in terms of a distance between a WTRU and the center of an antenna array or surface.

FIG. 4 is a diagram illustrating an example of a large array/surface size transmission under a non-LoS scenario.

FIG. 5 is a diagram illustrating an example of sub-array/sub-surface based CSI reporting in a CSI report group.

FIG. 6 is a diagram illustrating an example of partitioning a large array into multiple sub-arrays.

FIG. 7 is a diagram illustrating an example of a CSI report group with multiple CSI reports and CSI-RS ports.

FIG. 8 is a diagram illustrating an example of a CSI acquisition procedure for a large array/surface without WTRU assistance.

FIG. 9 is a diagram illustrating an example of CSI acquisition procedure for a large array/surface with WTRU assistance.

FIG. 10 is a diagram illustrating an example of a spot beam focusing the beam energy on a specific location.

FIG. 11 is a diagram illustrating an example of bundling two CSI-RSs.

FIG. 12 is a flow chart diagram illustrating an example of a method, implemented in a wireless transmit/receive unit, WTRU, for supporting near field operations.

### DETAILED DESCRIPTION

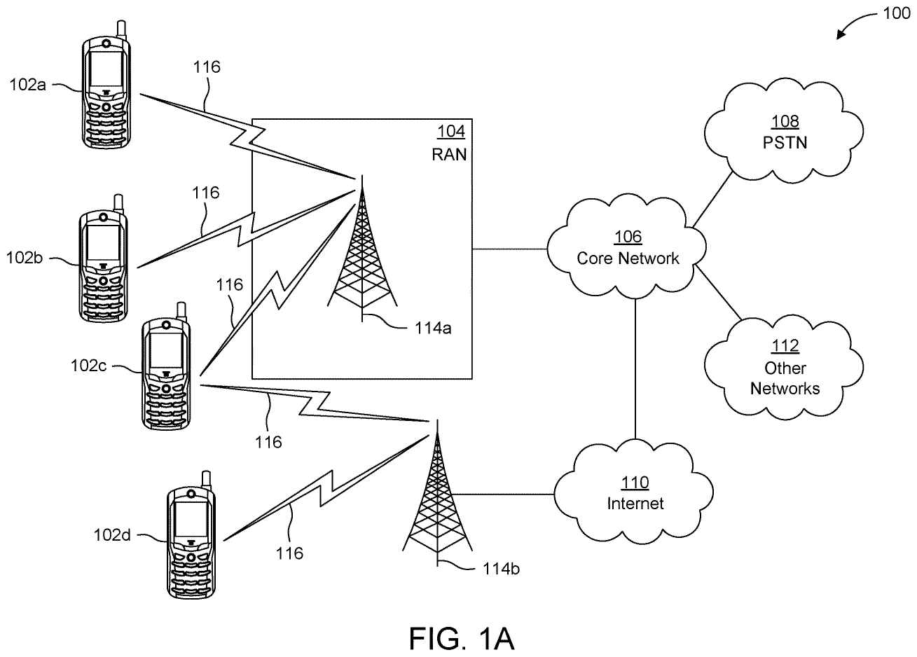

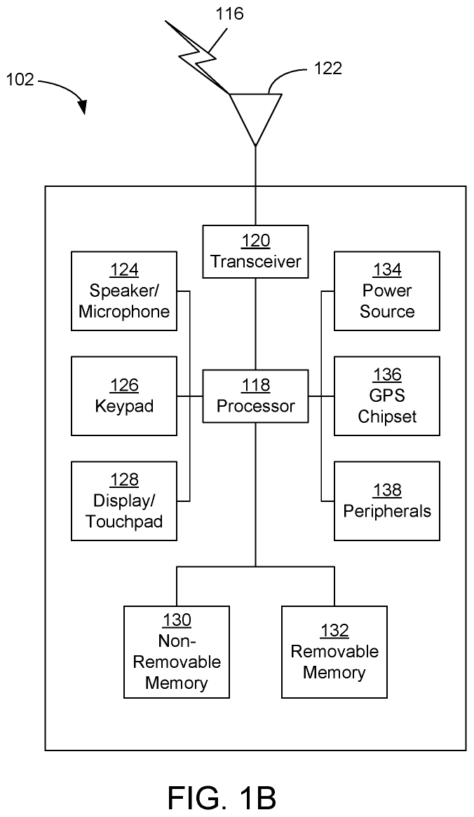

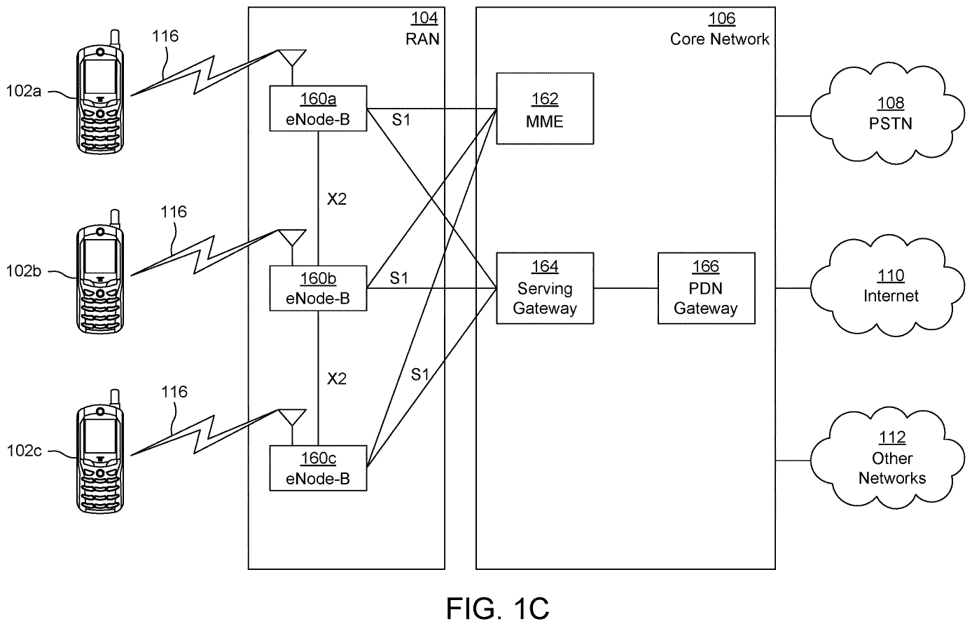

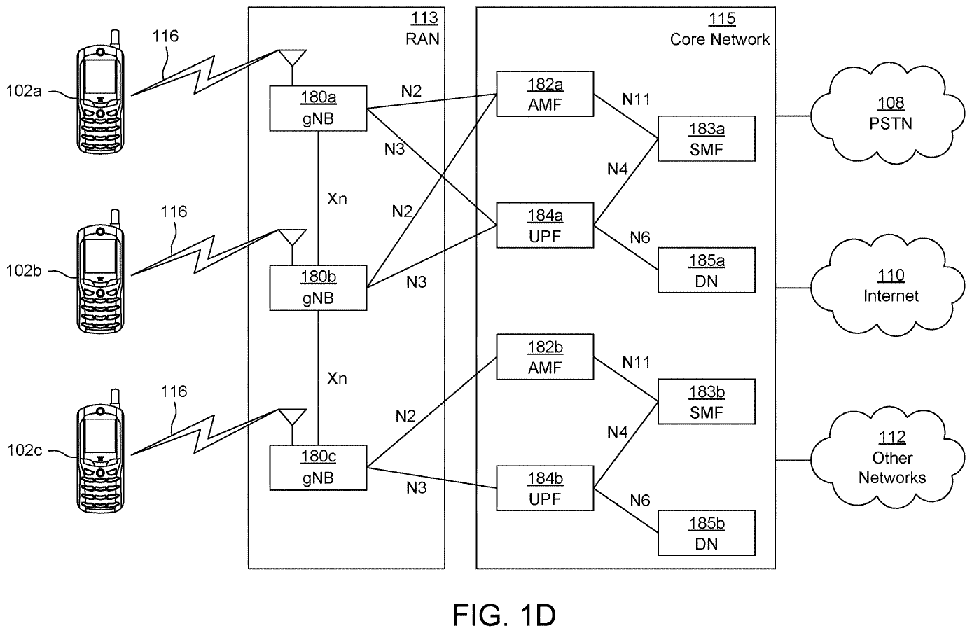

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

If an antenna or an antenna surface size becomes comparable to a link distance, the operating conditions of a WTRU may fall within a Fresnel region in which near field propagation may take place. In the examples provided herein, the term “array,” “metasurface,” or “surface” may be used interchangeably. If an array aperture D (e.g., D may be the smallest diameter of a circle that encloses an array aperture) is much larger than a wavelength 1, the electromagnetic propagation regime may be pushed from a Fraunhofer far field region toward the Fresnel region. The Rayleigh distance (e.g., R=2D²/λ) may be used as a reference point for distinguishing the far field region and the near field region. For a uniform planar array (UPA), the array aperture D may be derived based on geometry information such as the width and height of the UPA. For example, if a UPA is with N₁ antennas in the horizontal direction, N₂ antennas in the vertical direction and the antenna separation is equal to a half wavelength

$$( e . g . , \frac{λ}{2} ) ,$$

the array width may be equal to

$$\frac{{N}_{1} λ}{2}$$

and the array height may be equal to

$$\frac{{N}_{2} λ}{2} .$$

In this case, the smallest diameter D of a circle that encloses the UPA aperture may be equal to

$$\sqrt{{( \frac{{N}_{1} λ}{2} )}^{2} + {( \frac{{N}_{2} λ}{2} )}^{2}} = \sqrt{{N}_{1}^{2} + {N}_{2}^{2}} \frac{λ}{2}$$

and the Rayleigh distance may be derived as

$$R = \frac{2 {( \sqrt{{N}_{1}^{2} + {N}_{2}^{2}} )}^{2} \frac{λ}{2}}{λ} = {N}_{1}^{2} + {N}_{2}^{2} .$$

If the antenna separation is equal to a quarter wavelength

$$( e . g . , \frac{λ}{4} ) ,$$

the Rayleigh distance may be derived as

$$R = \frac{2 {( \sqrt{{N}_{1}^{2} + {N}_{2}^{2}} )}^{2} \frac{λ}{4}}{λ} = \frac{1}{2} ( {N}_{1}^{2} + {N}_{2}^{2} ) .$$

The UPA (or an uniform linear array (ULA) and/or the Rayleigh distance R may be uniquely determined by the number of antennas in the horizontal direction, the number of antennas in the vertical direction, and the antenna separation.

Examples of Rayleigh distances R with various array aperture D with a square array and carrier frequencies (f_{c}) are shown in Table 1 below. For a square array aperture, the array aperture D may be equal to the diagonal of the square array, e.g., D=\sqrt{2}L, where L may be the side of a square array. Based on Table 1, Fresnel zone criteria may occur at a (e.g., any) frequency range and the Rayleigh distance may be up to several kilometers (kms). The Rayleigh distance may be proportional to the inverse of the wavelength if, for example, the area of the array is fixed. A Fresnel near field effect may be more noticeable in a high frequency region (e.g., the Rayleigh distance may be larger in the high frequency range than a low frequency range).

TABLE 1
Rayleigh distance for different square planar apertures

| Size | R [m] @ | R [m] @ | R [m] @ | R [m] @ |
|---|---|---|---|---|
| L [m] | 3 GHz | 28 GHz | 73 GHz | 142 GHz |
| 0.05 | 0.0500 | 0.4670 | 1.2175 | 2.3683 |
| 0.1 | 0.2 | 1.9 | 4.9 | 9.5 |
| 0.5 | 5 | 46.7 | 121.7 | 238.3 |
| 1 | 20 | 186.7 | 486.7 | 953.3 |
| 3 | 180 | 1680 | 4380 | 8580 |

The number of elements (e.g., antenna elements) in an array may be proportional to the area of the array, e.g., as shown in Table 2 below. Assuming the array illustrated by Table 2 is a square, if the transmit array aperture D) (e.g., the transmit array aperture may be associated with a WTRU, a gNB, or both) is determined and the operating frequency is fixed, then the Rayleigh distance may be known. This may mean that near field criteria may be dependent on the array aperture D at a specific operating frequency. The number of elements in a square UPA may be illustrated in Table 2, which shows that the number of elements in a square UPA may be large (e.g., extremely large) for a higher frequency range.

TABLE 1
$number of elements per array aperture when antenna separation Δ = λ / 2 , M = ⌊ \frac{L}{Δ} ⌋$

| | M² @ 3 GHZ | M² @ 28 GHz | M² @ 73 GHZ | M² @ 142 GHz |
|---|---|---|---|---|
| L[m] | λ = 0.0999 [m] | λ = 0.0107 [m] | λ = 0.0041 [m] | λ = 0.0021 [m] |
| 0.1 | 4 | 324 | 2304 | 8836 |
| 0.5 | 100 | 8649 | 59049 | 223729 |
| 1 | 400 | 34596 | 237169 | 896809 |
| 3 | 3600 | 313600 | 2134521 | 8071281 |

A Fresnel near-field channel model may be established and/or used. For simplicity and without losing generality, a near-field channel model in line-of-sight (LOS) may be as follows.

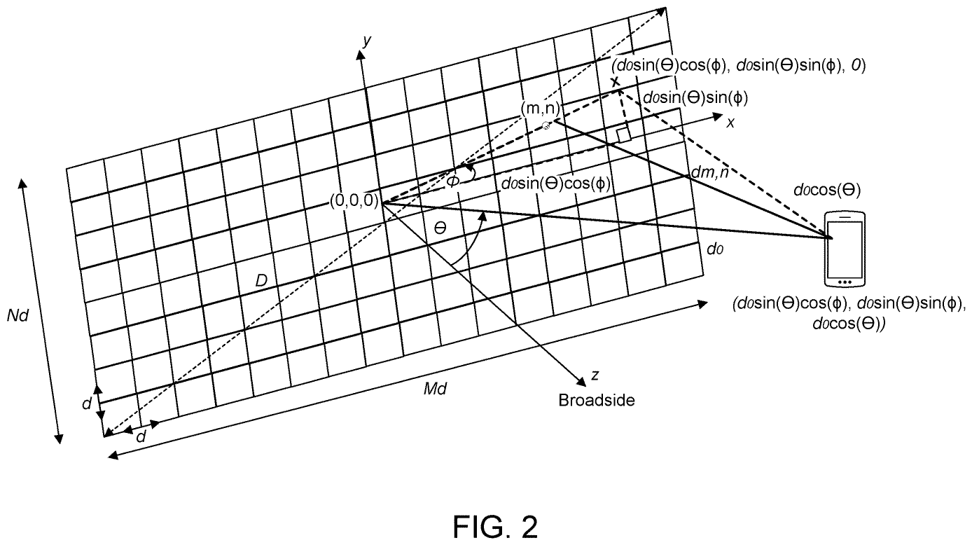

Let d₀ denote the distance from a WTRU to the center of an array or surface, d_{m,n} denote the distance from the WTRU to the (m, n)th antenna/element, and θ and φ denote the zenith/elevation and azimuth angles (or angle of departure (AoD)), respectively. The WTRU location/coordinates may be determined as follows: (x, y, z)=(d₀ sin θ cos φ, d₀ sin θ sin φ, d₀ cos θ) and the (m, n)th antenna coordinates may be (mΔ, nΔ, 0), e.g., as shown in FIG. 2. Here, Δ may denote an inter-element distance (or antenna separation) for the horizontal and/or vertical directions. The distance between the WTRU and the (m, n)th antenna element may be expressed as Eq. (1) below.

$${r}_{m , n} = {( {d}_{0} sin θ cos ϕ - m Δ )}^{2} + {( {d}_{0} sin θ sin ϕ - n Δ )}^{2} + {( {d}_{0} cos θ )}^{2} \qquad ( Eq 1 )$$

$${r}_{m , n} = {d}_{0} \sqrt{1 - 2 m {α}_{1} \frac{Δ}{{d}_{0}} - 2 n {α}_{2} \frac{Δ}{{d}_{0}} + ( {m}^{2} + {n}^{2} ) {( \frac{Δ}{{d}_{0}} )}^{2}} ,$$

$${r}_{m , n} = {d}_{0} \sqrt{1 + ( ( {m}^{2} + {n}^{2} ) {( \frac{Δ}{{d}_{0}} )}^{2} - ( 2 m {α}_{1} + 2 n {α}_{2} ) \frac{Δ}{{d}_{0}} )} ,$$

where α₁=sin θ cos φ, and α₂=sin θ sin φ. The value α₁=sin θ cos φ and α₂=sin θ sin φ may be obtained based on a far field condition, which may have |θ₁|≤1 and |α₂|≤1.

From the 1^{st} order Taylor series,

$$\sqrt{1 + x} \approx 1 + \frac{x}{2} , \qquad Eq . ( 1 )$$

may be simplified as

$${r}_{m , n} \approx {d}_{0} ( 1 + \frac{( {m}^{2} + {n}^{2} ) {( \frac{Δ}{{d}_{0}} )}^{2}}{2} - ( m {α}_{1} + n {α}_{2} ) \frac{Δ}{{d}_{0}} ) \qquad ( Eq 2 )$$

and the phase shift between the (m, n)th antenna element and the WTRU may be expressed as

$${ψ}_{m , n} = {k}_{0} {r}_{m , n} ,$$

where

$${k}_{0} = \frac{2 π}{λ}$$

may denote a wave number.

The phase of spherical waves may be derived (e.g., in near field regions) from the geometry location of a UPA, which may a non-linear function of the antenna index. Near field beamforming may focus beam energy on a specific location, e.g., by exploiting the extra distance information of spherical wavefronts. Beamforming in the near field may also be referred to herein as beamfocusing.

If the nonlinear phase term

$$\frac{1}{2} ( {m}^{2} + {n}^{2} ) {( \frac{Δ}{{d}_{0}} )}^{2} ∼ 0 ,$$

then the distance between the WTRU (e.g., a user) and the (m, n)th antenna element r_{m,n} in Eq. (2) may be simplified as

$${r}_{m , n} \approx {d}_{0} ( 1 - ( m {α}_{1} + n {α}_{2} ) \frac{Δ}{{d}_{0}} ) \qquad ( Eq 3 )$$

$${r}_{m , n} \approx {d}_{0} - ( m {α}_{1} + n {α}_{2} ) Δ .$$

From Eq. 3, the distance between the (m, n)th antenna element and the WTRU may become a linear relationship. Using Eq. (3), the phase shift between the (m, n)th antenna element and the WTRU may be expressed as

$${e}^{j 2 {πψ}_{m , n}} = {e}^{j 2 π {k}_{0} {r}_{m , n}} = {e}^{j 2 π {k}_{0} ( {d}_{0} - ( m {α}_{1} + n {α}_{2} ) Δ )} \qquad ( Eq . 4 )$$

$${e}^{j 2 {πψ}_{m , n}} = {e}^{{jk}_{0} {d}_{0}} {e}^{- j {k}_{0} ( m {α}_{1} + n {α}_{2} ) Δ}$$

From Eq. (4), the phase shift between the WTRU and the (m, n)th antenna element may be simplified to a linear phase, which may be dependent (e.g., only dependent) on the AOD information (e.g., the elevation, zenith/elevation angles, etc.). Based on this, a far field condition may occur if the non-linear term

$$\frac{( {m}^{2} + {n}^{2} ) {Δ}^{2}}{2 d}$$

in Eq. (2) is vanished.

The near field region may be further partitioned as two regions, e.g., near field region I and near field region II. The partition may be determined based on the distance between the WTRU and the center of the array or metasurface. For example, if the distance between the WTRU and the center of the array or metasurface is greater than ηD (e.g., η=8), then near field region I criteria may be met. In near field region I, a near field channel coefficient (or gain) may be dependent on d₀ for one or more (e.g., all) antenna elements (e.g., as if under a far field assumption), but the phase shift between the (m, n)th element and the WTRU may be dependent on the distance between the WTRU and a (e.g., each) (m, n)th antenna element location, e.g., r_{m,n}.

It should be noted that array aperture D may not be infinite since, for example, if array aperture D is larger than a threshold (e.g., 10 meters), the channel gain may not increase proportionally with the array aperture D. It may be assumed that near field region II may be limited to a small range (e.g., in terms of distance). If near field region II condition criteria are met (e.g., the distance between the WTRU and the center of the array or metasurface d₀≤ηD), the channel coefficient and/or channel gain may be dependent on

$${d}_{0}^{2}$$

and the phase shift between the (m, n)th element and the WTRU may be as in near field region I.

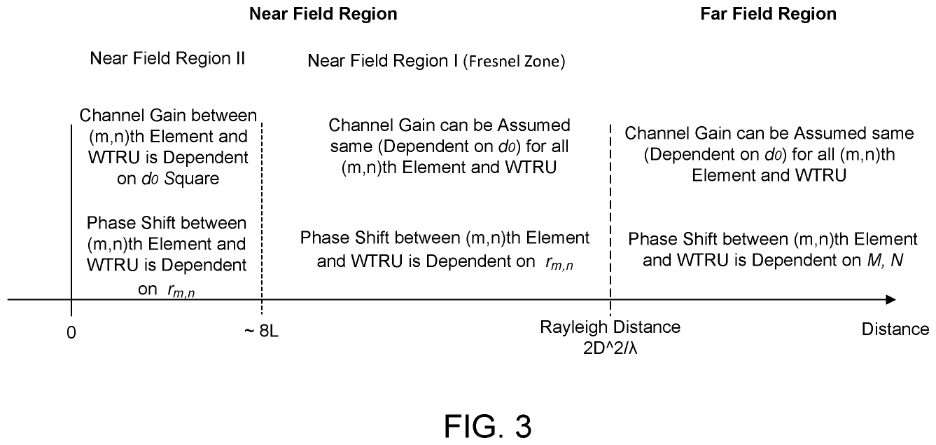

FIG. 3 illustrates near field and far field regions of an M×N array or metasurface.

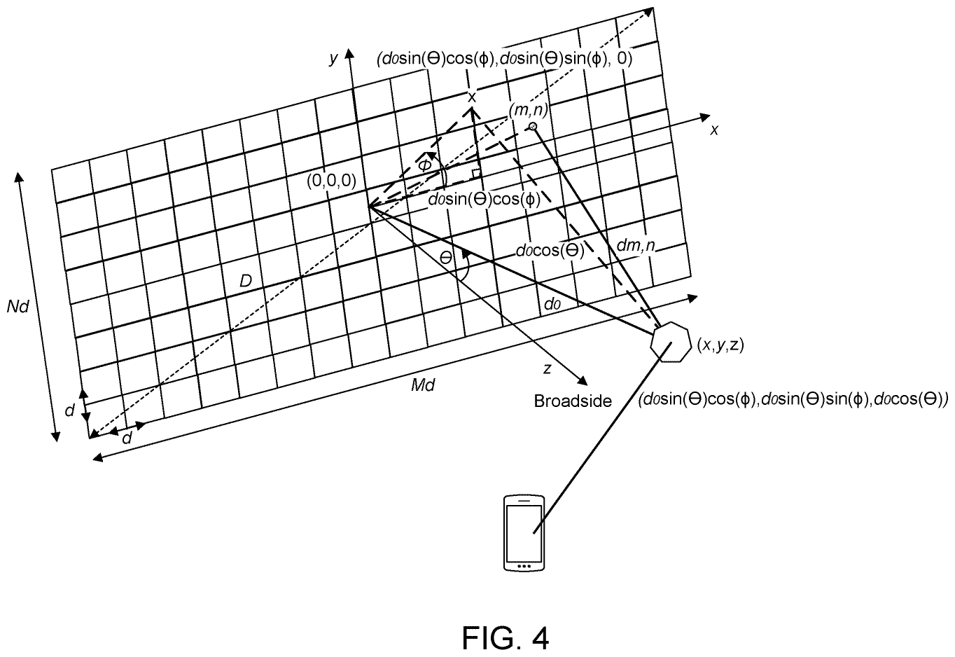

Eq. (1) shown herein may be applied for a non-LOS (NLOS) path case. If there is an NLOS path between a WTRU and an array or surface, Eq. (1) may be valid and/or the phase shift between the WTRU and the (m,n)th antenna element may be equivalent to the distance between a scatterer and the center of the (m,n)th antenna element, as illustrated by FIG. 4. This may be because the phase shift between the WTRU and the (m,n)th antenna element NLOS path may be dependent (e.g., only dependent) on the distance between the scatterer and the center of the (m, n)th antenna element. If there is no LOS path between the WTRU and a gNB (e.g., only NLOS paths are between the WTRU and the gNB), then the distance between the WTRU and the gNB may be defined as the distance from the WTRU to the scatterer and the angles (e.g., θ and φ) may be based on the direction from the scatterer to the gNB. This may be because the distance in the path from the gNB to a scatterer may be common to multiple (e.g., all) antenna elements, and thus the phase shift may be calculated from the WTRU to the scatterer.

An effective Rayleigh distance may be determined and/or used to improve a demarcation boundary for a far and/or near field. Such an effective Rayleigh distance may be less than a conventional Rayleigh distance. The effective Rayleigh distance may be related to an AOD direction (e.g., θ). The effective Rayleigh distance may be defined from the perspective of array gains that may affect a transmission rate and, as such, the effective Rayleigh distance may be an accurate metric for determining the near field range for practical communications. The effective Rayleigh distance may be defined as follows:

$${R}_{eff} = {ε ( cos θ )}^{2} R \leq ε \frac{2 {D}^{2}}{λ} , \qquad Eq . ( 5 )$$

$$where$$

$$ε = 0. 367 .$$

Based on the effective Rayleigh distance defined by Eq. (5), a conventional Rayleigh distance (RD) may be overestimated. The effective Rayleigh distance may be used for determining a demarcation boundary for a far field and/or a near field. The effective Rayleigh distance may possess the same (e.g., substantially similar) properties as the conventional Rayleigh distance. For example, the effective Rayleigh distance may be proportional to the inverse of the wavelength and/or the square of the array aperture.

Under near field criteria, an accurate spherical wave model may be adopted for the channel model described herein. A near field beamformed vector w(d₀, θ, φ) (e.g., which may be used for beamfocusing) may be dependent on parameters such as a distance (e.g., d₀) and/or an angle (e.g., (θ, φ)). A generated near field beam may focus signal energy around or on a desired location (e.g., a WTRU location with a spatial direction (θ, φ)). A beamfocused beam may focus the beam energy on (e.g., only on) a specific location in a spatial direction. Such a beamfocused beam may be referred to herein as a spot beam.

Beamfocusing may be considered for a near field. A near field condition may occur, for example, if an array or metasurface dimension is increased and/or a link distance is reduced. When such a condition occurs, conventional beamforming techniques for a far field may not be able to ensure array gains for the near field because, for example, the conventional beamforming techniques may consider an elevation and/or an azimuth angle and not the near field condition that may be associated with ternary parameters such as distance (e.g., the distance between a WTRU and the center of an array or surface), elevation, and/or azimuth angle information.

Beamfocusing may be used to enhance communication performance in a near field. Beamfocusing may be realized, for example, by adjusting the beamforming weights applied on a transmitter side considering the distance between a WTRU and an (e.g., each) antenna element, an elevation, and an azimuth angle. Spherical wavefronts may be exploited to realize beamfocusing (e.g., which may also be referred to as near field beamforming) such that signals may be focused at a specific location.

A beamfocusing operation may be performed based on the distance between a WTRU and a base station (e.g., a gNB). A beamfocused beam may direct beam energy at a specific location in a spatial direction. The specific location may be dependent on the distance between the WTRU and the center of an array. The WTRU may determine whether it is under a near field condition for receiving a beamfocused beam (e.g., a spot beam) or not.

CSI acquisition and/or reporting associated with a beamfocusing operation under near field criteria may be performed. Array gains may be a factor for determining link budget and throughput in a wireless communication system. If a transmit array aperture D (note, the transmit array aperture could be for UE, gNB or both) is determined and/or the operating frequency is fixed, a Rayleigh distance or effective Rayleigh distance may be known. Near field criteria may be dependent on the array aperture D at the operating frequency. For a given Rayleigh or effective Rayleigh distance, the (e.g., minimum) number of antennas in a UPA with aperture D may be determined. For example, the number of antennas in an array may be large, as illustrated by Table 2. Therefore, to utilize the antennas within a UPA aperture for transmission may involve a large amount of CSI information, which may be difficult to obtain. For example, the maximum number of CSI-RS ports for CSI acquisition may be limited (e.g., to 32 ports). Hence, to support more than the maximum number of CSI-RS ports (e.g., more than 32 ports) for CSI acquisition, an existing CSI acquisition framework may be extended. Increasing the number of CSI-RS ports for CSI acquisition may also increase the CSI-RS resource overhead in the downlink (DL) and/or the feedback overhead in the uplink (UL).

Based on Eq. (4) provided herein, if a WTRU is under far field conditions (e.g., where the distance between the WTRU and one or more (e.g., all) antenna elements is larger than an Rayleigh or an effective Rayleigh distance), CSI acquisition between the WTRU and a gNB/TRP may be simplified to estimate the far field AOD/AOA under the far field conditions. Under these far field conditions, CSI acquisition may become easier because, for example, it may not be necessary to estimate the phase shift between the WTRU and a (e.g., each) antenna element in an array or a surface, and/or the distance between the WTRU and the array or surface. Under the far field conditions, the phase shift between the WTRU and the array or surface (e.g., the center of the array or surface) may be estimated.

A network entity such as a base station (e.g., a gNB or another network device) may have knowledge about the coarse distance between a WTRU and the network entity. Such knowledge may be obtained, for instance, based on an estimation of a PRACH propagation delay, via a WTRU positioning technique, using gNB/TRP-based sensing to obtain the distance estimation, and/or based on the WTRU's global positioning system (GPS) information, if available. If the network entity has the distance information and/or the ability to determine whether the WTRU is in a near field or not, the network entity may use the information to decide whether to proceed with performing near-field CSI acquisition or not (e.g., if the WTRU is determined to be under near-field conditions). The distance and/or position estimation may be used as a factor in determining whether the WTRU is under the near-field conditions before CSI acquisition is performed. The network entity may perform the distance estimation before performing near-field CSI acquisition.

A method for reducing a near-field effect may include reducing an effective transmission array aperture and/or a Rayleigh distance or an effective Rayleigh distance. Using a small transmission array aperture for beamforming may imply that wider beams are used to transmit a reference signal (e.g., a beamformed CSI-RS). Using the wider beams may imply that beam widths are wider and/or that beamformed angles are wider. In these cases, a WTRU may not be able to extract angle information directly from the wider beam width. A small transmission area may also make it difficult to achieve high array gains. Near field beam training (e.g., beamfocusing) may be derived from far field beam training. An array may be partitioned into multiple sub-arrays, and the WTRU may be assumed to be located within a near field range of the array and within a far field range of a (e.g., each) sub-array.

An network entity such as a gNB or another network device may select a proper transmission array aperture to balance the near field effect, a beamformed resolution and array gains. Using a small transmission array aperture may reduce the size of a near field zone. The network entity may choose using a larger transmission aperture for a WTRU to achieve better array gains and/or a beamformed resolution (e.g., such that the data throughput may be increased). If an effective transmission aperture is getting large, the near field effect may get also large and massive transmission antenna elements may be used for the transmission. In these case, a full CSI acquisition may become challenging. Therefore, the full CSI acquisition (e.g., for a near field) may be decomposed into multiple partial CSI acquisitions that may be associated with respective sub-arrays. This way, the full CSI acquisition for the near field may be accomplished through the partial CSI acquisitions.

Obtaining the full CSI from the partial CSI may be advantageous. For example, the CSI resources associated with the full CSI may be reduced and feedback overhead may also be reduced. For instance, to obtain a full CSI from an array with M=100 antenna elements, 100 CSI-RS ports may be used (e.g., assume no beamforming is applied to the antenna ports) and this may lead to larger CSI-RS resource usage and/or feedback overhead. If the full CSI is obtained based on partial CSI, CSI-RS resources such as antenna ports may be saved and/or feedback information may be reduced.

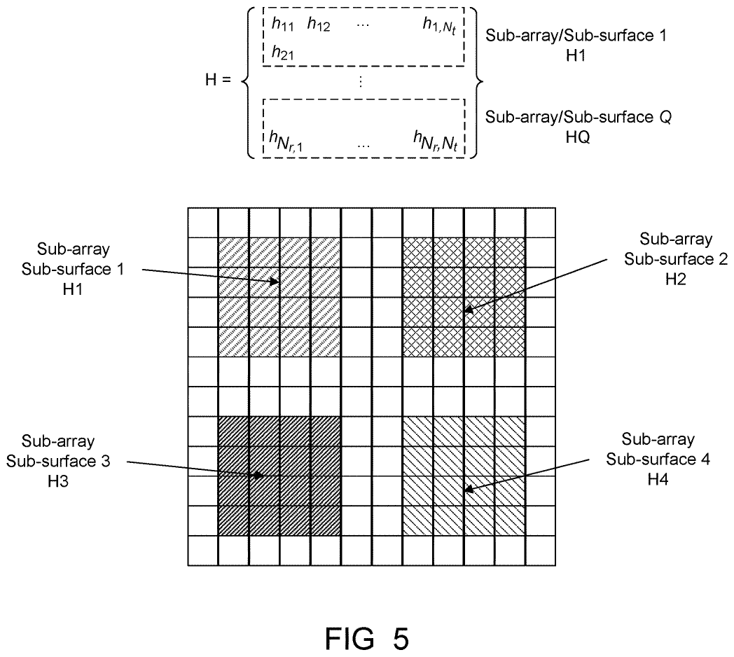

A partial CSI may be obtained using different techniques. FIG. 5 illustrates an example of a design, where some smaller transmission areas (e.g., sub-array Sᵢ, i=1 . . . Nₛ, each of which may be associated with Mᵢ antenna elements) may be selected from a large array with M antenna elements for partial CSI acquisition. A network entity such as a base station (e.g., gNB) or another network device may select some antenna elements (e.g., Mᵢ elements) from a large array with M antenna elements. In this case, Mᵢ<M antenna ports may be used for the partial CSI acquisition. The selection or partition of the sub-arrays may be dynamically adapted based on channel conditions and may be WTRU-specific. In this manner, a WTRU may be assumed to be located within the near field range of the large array and in the far field range of a (e.g., each) sub-array. The large array (or a part of the large array) may be split into multiple sub-arrays, where the multiple sub-arrays may share a common phase shift (e.g., with the same phase adjustment). The network entity may utilize a CSI report associated with a sub-array to extract angle information (e.g., as for a far field channel condition) and may obtain a partial CSI report based on this operation. The network entity may then construct a full CSI report based on one or more such partial CSI reports. For example, if a UPA is equipped with 100 antennas and assuming all of the antennas are used for CSI acquisition, then N₁N₂=100 CSI-RS ports may be used for CSI reporting (e.g., if single polarization is assumed). If Nₛ (e.g., Nₛ=2) sub-arrays Sᵢ (e.g., i=1, 2) are selected from the large array for partial CSI reporting and each sub-array Sᵢ is associated with Mᵢ such as Mᵢ=25=5×5 antenna elements, where i=1, 2, then 25 CSI-RS ports may be used for a CSI report (e.g., a partial CSI report), resulting in a saving of 50% CSI-RS resources (e.g., 50 CSI-RS ports versus 100 CSI-RS ports).

A network entity such as a base station or another network device may group antenna elements contained in a sub-array (e.g., square sub-array) into a sub-group for sharing approximately the same phase shift. This may be because the variations of angles (e.g., elevation and/or azimuth angles), the distance between a WTRU and an (e.g., each) element inside the same sub-group may be small. In this way, the number of phase-shift estimation may be reduced, for example, to the number of split sub-arrays.

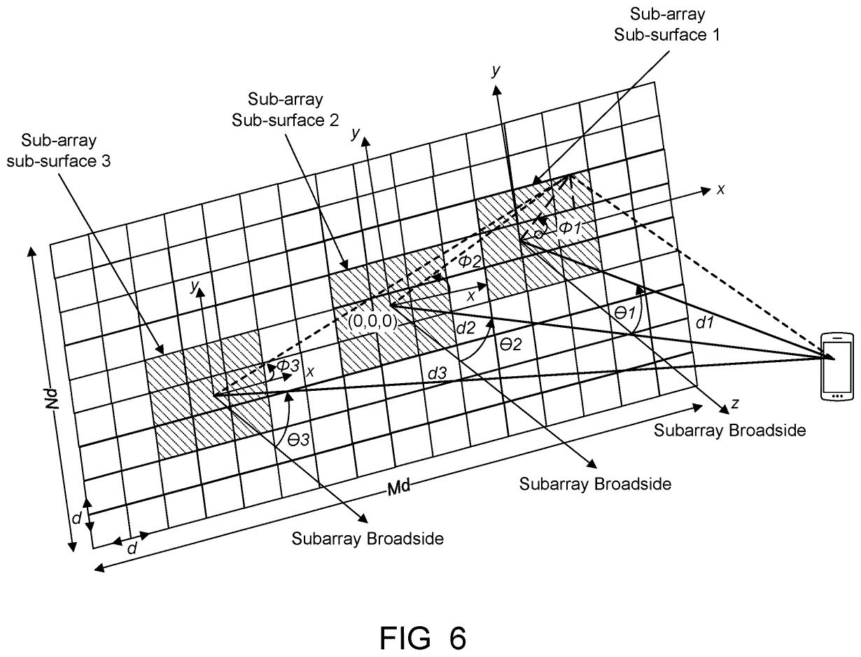

FIG. 6 illustrates an example of partitioning a large array into three sub-arrays for a WTRU to perform CSI acquisition. In this example, three CSI reports may be configured for the WTRU to perform CSI acquisition. Each CSI acquisition may be treated as for a far field condition (e.g., similar to conventional CSI estimation). Phase shifting may be treated as same within the same sub-array. In this way, the phase shift between the WTRU and an (e.g., each) element in the large array may be reduced. Spatial parameters such as elevation and azimuth angles may be estimated individually from a (e.g., each) sub-array. For example, as shown in FIG. 6, three spatial direction parameters, e.g., (θ₁, φ₁), (θ₂, φ₂), . . . , (θ_{Q=3}, φ_{Q=3}), may be estimated.

In examples, if there is an LOS path between a (e.g., each) sub-array and the WTRU, the estimation of spatial direction, e.g., (θ₁, φ₁), (θ₂, φ₂), . . . , (θ_{Q}, φ_{Q}) may be applied (e.g., directly applied) for the angle of arrival (AOA) and angle of departure (AOD) estimation between the WTRU and a (e.g., each) sub-array. Full CSI may be obtained if an LOS path exists between the WTRU and a (e.g., each) element in the array. If there is an NLOS path between the WTRU and the sub-array, spatial direction estimation may become more challenging (e.g., compared to the LOS case). This may be because the NLOS path may be associated weaker signal strength. A network entity such as a base station or another network device may schedule the WTRU to transmit an SRS to obtain an initial CSI (e.g., by utilizing channel reciprocity in a TDD system to assist with full DL CSI acquisition).

Partial CSI acquisition may be performed as follows. A WTRU may be configured with multiple CSI reports (e.g., in a CSI report group) and a (e.g., each) CSI report within the configured multiple CSI reports (or the CSI report group) may correspond to a separate CSI resource for a sub-array. This way, a full CSI may be split into multiple partial CSIs and a (e.g., each) partial CSI may be linked with a sub-array or sub-surface (e.g., the WTRU may be configured with multiple CSI reports in a CSI report group and each CSI report may be associated with partial CSI for a sub-array/sub-surface).

As described herein, multiple CSI reports such as CSI reports #1, . . . #Q (e.g., Q may be equal to one to support a single CSI report in a CSI report group) may be grouped into a CSI report group (e.g., since those CSI reports may be associated with sub-arrays of a same array). A (e.g., each) CSI report in the CSI report group may be configured by the network (e.g., via a CSI-ReportConfig information element (IE), for example, with a report quantity (or type) set to “CSI compression.” This report quantity may differentiate the partial CSI report (e.g., in the CSI report group) from existing CSI report quantities such as rank indication (RI), channel quality indication (CQI), precoder matrix indication (PMI), CSI-RS resource indicator (CRI), etc. A WTRU may compress the partial CSI reports #1, . . . #Q.

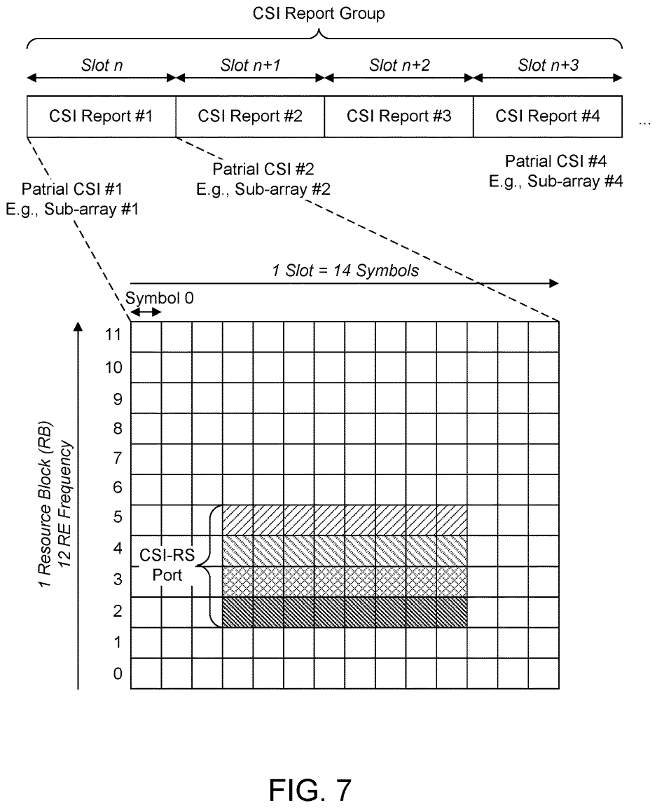

For a partial CSI report described herein (e.g., with report quantity set to “CSI-compression”), one or more CSI-RS ports in a CSI-RS resource configuration may be used for channel estimation (e.g., similar to CSI-RS ports used for the PMI reporting). The CSI-RS ports may correspond to respective transmission (logical) antennas. A CSI-RS resource for the partial CSI report may have multiple CSI-RS ports. For example, as shown in FIG. 7, a CSI report group may be configured with multiple CSI reports (e.g., CSI reports 1, 2, 3 and 4), each CSI report may have its own CSI-RS resource configuration, and/or the configured CSI-RS resource may be associated with multiple CSI-RS ports (e.g., Q-4 CSI-RS ports may be configured for a CSI-RS resource). A transmission antenna in a sub-array may be mapped to a CSI-RS port associated with a CSI-RS resource such that CSI may be determined based on the CSI-RS port.

A WTRU may use one or more CSI-RS ports associated with a CSI-RS resource. A non-precoded reference signal (e.g., CSI-RS) received via the DL at the pth port, using the kth subcarrier/resource element (RE) and at an Rx antenna may be expressed as

$${y}_{k , p} = {h}_{k , p} + {n}_{k , p} \qquad Eq . ( 5 )$$

where

$${h}_{k , p} = {h}_{k , p}^{H} w$$

if the received reference Signal (e.g., CSI-RS) is precoded, (⋅)^{H} may denote conjugate transpose, hₖ may denote the CSI at the kth subcarrier, h_{k,p}∈N_{b}×1 may denote the CSI vector at the kth subcarrier for port p, w∈N_{b}×1 may denote a corresponding precoding vector, and nₖ may denote the additive noise. The DL CSI matrix q for the qth CSI report (q=1 . . . Q) may be formed as follows:

$${H}_{q} = ⌈ {h}_{1} … {h}_{P} ] , \qquad Eq . ( 6 )$$

where

$${h}_{p} = {[ {h}_{1 , p} , … {h}_{K , p} ]}^{T} ∈ {ℂ}^{K \times 1}$$

may denote a channel vector if the RS is for port p, (⋅)^{T} may denote transpose and K may denote the number of subcarriers/REs used in the CSI report q. The bandwidth of CSI report q may be based on a wideband or a narrow band. The bandwidth of CSI report q may be configured via RRC or MAC configuration, for example.

A WTRU may perform CSI compression such that Ha for CSI report q may be encoded at the WTRU (e.g., to reduce feedback overhead). H_{q} may be assumed based on far field conditions because a small array may be used for CSI H_{q}. Let fₑₙ(H_{q}) denote the output of the compressed CSI for CSI H_{q}, the WTRU may report the quantized compressed CSI fₑₙ(H_{q}) in a CSI report. The quantized compressed CSI fₑₙ(H_{q}) may denote f_{qu}(fₑₙ(H_{q})), where f_{qu}(⋅) may denote a quantization function. The compression algorithm fₑₙ(⋅) may be based on AI/ML or eigen-vectors algorithms.

The WTRU may feedback the quantized bits f_{qu}(fₑₙ(H_{q})) to a base station (e.g., a gNB/NB). Once the base station receives the quantized compressed CSI f_{qu}(fₑₙ(H_{q})), q=1, . . . , Q from the WTRU, a (e.g., each) CSI H_{q}, q=1, . . . , Q, may be recovered by the base station. The recovered DL CSI matrix for CSI report q may be expressed as follows:

$${\tilde{H}}_{q} = {f}_{d e} ( {f}_{e n} ( {H}_{q} ) ) \qquad Eq . ( 7 )$$

Multiple CSI reports or a CSI report group (e.g., CSI report q=1, . . . , Q) may be individually feedback to a base station (or another network device), for example, via multiple feedback channels (e.g., long PUCCHs or PUSCHs) or the CSI reports may be jointly feedback to the base station via a feedback channel (e.g., PUSCH). The multiple (e.g., Q) CSI reports within the CSI report group may be compressed jointly. This may be because channels H₁, H₂, . . . H_{Q} may have high correlation and thus a joint compression may achieve better compression gain than individual compressions. An encoder may take Q channels as the input for jointly compressing the Q channels, and a joint CSI compression function may be expressed as fₑₙ(H₁, H₂, . . . H_{Q}). The quantized compressed CSI bits f_{qu}(fₑₙ(H₁, H₂, . . . H_{Q})) may be used for the joint feedback of the Q CSI reports. A joint compression indication may be included in a CSI report configuration.

An example method for CSI acquisition associated with near field beamfocusing may include the following.

At 0, a WTRU may be scheduled for SRS transmission. For a TDD system, a base station (e.g., gNB) may obtain CSI information by utilizing DL/UL reciprocity of angle and delay. In these cases, the base station may transmit beamformed CSI-RS for the WTRU.

At 1, the WTRU may be triggered with a CSI report group. The CSI report group may include multiple CSI reports. The type of one or more CSI reports (e.g., each CSI report) may have a report type set to a specific value such as “CSI compression.”

At 2, the WTRU may perform CSI acquisition based on a CSI report configuration. The CSI report configuration may correspond to a CSI resource configuration. The WTRU may perform CSI compression (e.g., individually) for the CSI report associated with the CSI report configuration. The WTRU may perform a joint CSI compression (e.g., of multiple CSI reports) for joint CSI feedback.

At 3, the WTRU may feedback quantized bits of a (e.g., each) CSI report to the base station. A distance estimation (e.g., for the distance between the WTRU and the base station) may be performed based on the CSI report at the base station. For example, the base station may use the received CSI feedback from the WTRU to extract angle information (e.g., AoD, AoA, etc.) and/or path delay information for the distance estimation. The base station may request the WTRU to report the time of arrival (ToA) or difference in ToA (DToA) of the CSI-RS configured for a (e.g., each) CSI report in the CSI report group. The ToA may be associated with the CSI feedback report. Therefore, the range difference between sub-arrays may be obtained and the base station may perform the distance estimation based on positioning or localization estimation (e.g., based on a TDoA-AOD positioning technique).

At 4, the WTRU may be scheduled for an SRS transmission, for example, to assist with DL full CSI acquisition. This operation may also be performed before the operation at 1.

At 5, the base station may obtain partial CSI from the received feedback CSI report. The base station may extract spatial parameters (e.g., zenith/elevation and/or azimuth angles) from the partial CSI. The base station may construct full CSI based on the partial CSI (e.g., partial CSI #1, . . . #Q) and/or estimate the distance between the WTRU and the center of an antenna array.

At 6, the base station may construct a near field beamformed vector (e.g., for beamfocusing) based on an estimated distance and/or angle information that may be obtained from the estimated CSI. Such a near field beamformed vector may be associated with a beamfocused CSI-RS transmitted to the WTRU. The WTRU may measure the beamfocused CSI-RS and/or may report/feedback a selected CSI-RS Id or index (e.g., CRI) associated with L1-RSRP or L1-SINR to the base station. The base station may determine or adjust a beamfocused beam (e.g., based on the report/feedback from the WTRU) for PDSCH transmission.

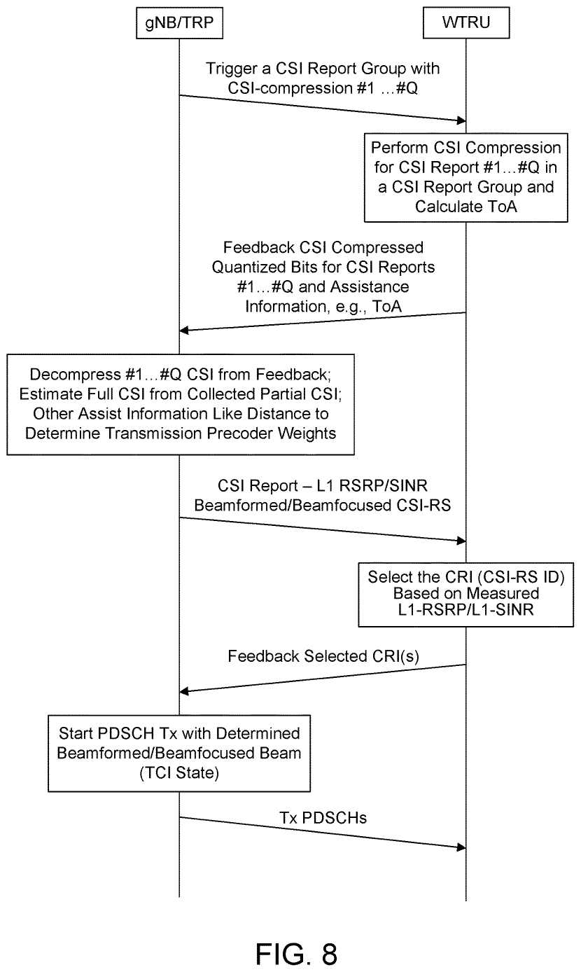

FIG. 8 illustrates an example of near field CSI acquisition without WTRU assistance (e.g., the operation described at 4 above that may be related to a WTRU being scheduled for an SRS transmission along with CSI reporting is omitted). The example illustrates a procedure that may be performed for handling a CSI report group for the determination of beamfocusing associated with a DL transmission. As shown, a base station (e.g., gNB) may configure a WTRU with sub-array based CSI reporting, for example, to obtain the spatial directions of one or more beams. The WTRU may assume that far field criteria are valid and may report a ToA as assistance information for the base station to calculate the range difference between sub-arrays. The base station may transmit one or more beamfocused CSI-RS's for the WTRU to select a preferred spot beam. The WTRU may report the selected beam (e.g., via a CRI) and/or the corresponding L1-RSRP or L1-SINR. The base station may use a full array to generate a single spot beam (e.g., beamfocused beam) or multiple spot beams for data (e.g., PDSCH) transmission.

A WTRU may be triggered to generate and/or transmit multiple CSI reports (e.g., up to 16 CSI reports) in an aperiodic CSI reporting period and each CSI report may be linked to a CSI resource set. For CSI reporting based on aperiodic (AP) CSI-RS reporting, a QCL assumption or a TCI state for the CSI report may be configured (e.g., via RRC signaling). In examples, the multiple CSI reports may be independent with each other (e.g., because the CSI reports may be from different TRPs and those TRP may be located at different geometrical locations). In examples such as when a base station triggers multiple CSI reports for different sub-arrays within a same large array (e.g., as shown in FIG. 6) for near field CSI acquisition, the triggered CSI reports may be highly correlated (e.g., they may have similar spatial directions and/or path delays). A CSI report group may be configured and/or used to indicate to a WTRU that the CSI reports included in the CSI report group may have high correlation with each other. Such a CSI report group may have one or more of the following properties.

Multiple CSI reports may be configured as belonging to a CSI group. The WTRU may assume that the CSI reports may be mapped to different sub-arrays, for example, as shown in FIG. 7. An AP CSI report may be triggered, which may include multiple CSI reports, and some of the CSI reports may be configured to belong to the same group in this trigger.

The group indication may be provided as follows. The grouping indication may be indicated in the CSI-AperiodicTriggerState information element (IE). An aperiodic trigger state may be configured for up to Q CSI repots, and each CSI report may be associated with a bit field to indicate whether the CSI report belongs to the same CSI group or not. For example, if an AP CSI report is triggered by a DCI (e.g., DCI format 0_1/0_2) and K (e.g., K=8) CSI reports (e.g., for respective sub-arrays) are associated with this AP CSI report, then a K-bit field such as a bitmap ‘11110000’ may be used to signal that four CSI reports are within a same CSI report group (e.g., bit=‘1’ may indicate that the corresponding CSI report belongs to the group).

The grouping indication may be indicated in a CSI-AssociatedReportConfigInfo IE. In this case, a ‘groupId’ may be included in the CSI-AssociatedReportConfigInfo IE to indicate the group ID in a corresponding report configuration. For example, if an AP CSI report is triggered by a DCI (e.g., DCI format 0_1/0_2) and K (e.g., K=8) CSI reports (e.g., for respective sub-arrays) are associated with this AP CSI report, then K CSI-AssociatedReportConfigInfo may be configured for each AP CSI report and the groupId in the K CSI-AssociatedReportConfigInfo may indicate to the WTRU which CSI report(s) belongs to the group with the groupId.

The grouping indication may be provided using a CSI-RS bundle. In this case, a (e.g., each) CSI-RS report may be configured with a CSI-RS resource set and a configured CSI-RS resource in the CSI-RS resource set may be bundled with other CSI-RS resource(s) in a different CSI-RS report. The WTRU may determine, based on the bundled CSI-RSs, that the bundled CSI-RS are associated with sub-arrays in a large array associated with a TRP.

The grouping indication may be provided via RRC signaling, a MAC CE, or a DCI, which may indicate joint feedback for CSI reports that are in the same group. For example, if an AP CSI report is triggered by a DCI (e.g., DCI format 0_1/0_2) and K (e.g., K=8) CSI reports (e.g., for respective sub-arrays) are associated with this AP CSI report, if four CSI reports of the K CSI reports are configured to be in the same group, and/or if joint feedback is enable, then the DCI may be used to schedule a PUSCH that may carry 5 CSI feedback reports (e.g., one feedback report for the four CSI reports that belong to the group plus four other feedback reports for the CSI reports that do not belong to the group).

A WTRU may provide assistance to CSI acquisition. A base station such as a gNB may partition a large array into multiple sub-arrays and may configure a CSI report for a sub-array for far field CSI. The base station may synthesize a full CSI based on the CSI associated with the sub-arrays and may use the full CSI for performing beamfocusing. The synthesis of the full CSI based on the sub-array CSI may use assistance parameters such as an estimated distance (e.g., the distance between the WTRU and the center of the array). The base station (or another network device) may request the WTRU to transmit ab SRS before or after sub-array CSI, e.g., to enhance the full CSI acquisition performance. For example, the CSI-RS corresponding to a middle sub-array may be used as a spatial reference, where the middle sub-array may be the sub-array that includes the center of the array (e.g., such as sub-array #2 shown in FIG. 7). The base station may schedule multiple SRS transmissions and each SRS transmission may be associated with a different QCL assumption. In this way, the base station may utilize the angle and/or path delay information (e.g., for a TDD system) and the base station may transmit a beamformed CSI-RS to the WTRU for CSI reporting.

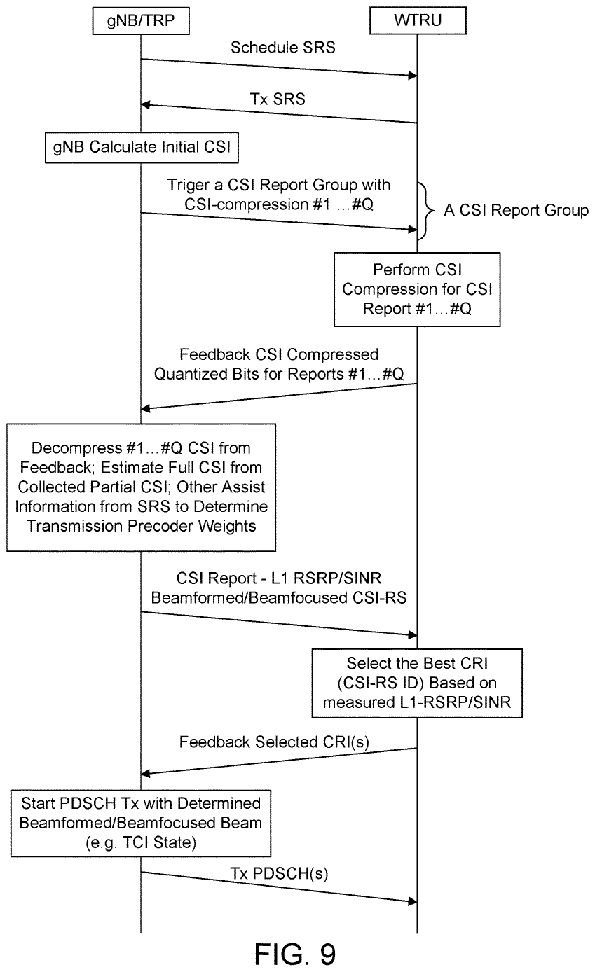

FIG. 9 illustrates an example of near field CSI acquisition with WTRU assistance (e.g., for the performance of beamfocusing related to a DL transmission). As shown, a base station such as a gNB may request or schedule a WTRU to transmit one or more SRSs to obtain initial channel state information. The base station may use different sub-arrays for SRS reception and may record the ToA information for each scheduled SRS. The base station may configure one or more sub-array-based CSI reports for CSI acquisition. The CSI may be beamformed and the WTRU may assume that far field criteria are valid. In some examples, the WTRU may report a ToA as assistance information for the base station to calculate a range difference between subarrays.

The base station may transmit one or more beamfocused CSI-RSs for the WTRU to select a preferred spot beam and the WTRU may report the selected beam (e.g., via a CRI) and the corresponding L1-RSRP and/or L1-SINR to the base station. The base station may use a full array to generate a single spot beam or multiple spot beams for data (e.g., PDSCH) transmission.

Near field beam training may be derived from far field beam training. For the far field beam training, spatial angle information may be estimated. A near field beamformed vector for a WTRU may be obtained based on partial CSI of multiple sub-arrays. A (e.g., each) spatial direction in a far field sub-array may determine a spatial angle and a relevant distance may be assumed to be very large so that a near field property may be ignored. Therefore, the near field beamformed vector that may be associated with beamfocusing may be synthesized by estimated spatial angles in the far field.

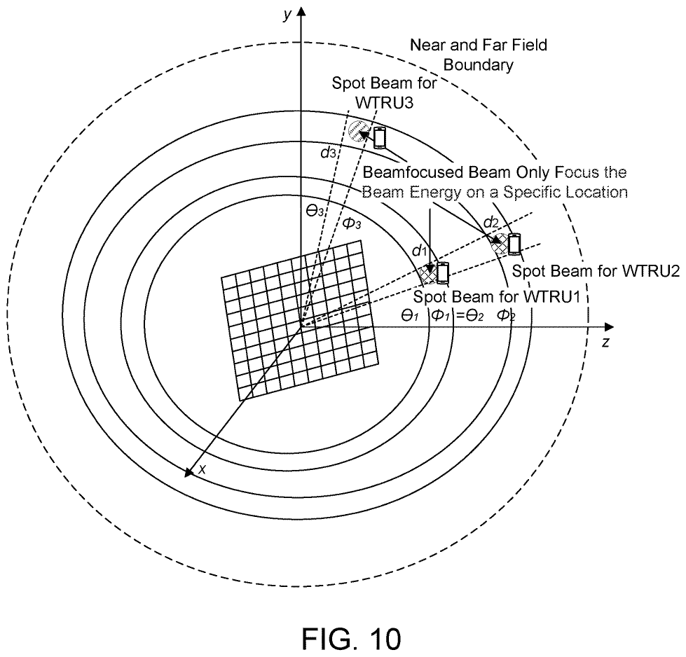

The estimation of a beamformed vector for beamfocusing in a near field may be based on distance information. Therefore, beamfocusing may be more challenging than beamforming (e.g., in a far field). A beamfocused beam may focus the beam energy at a specific location in a spatial direction. Therefore, a beamfocused beam may also be referred to as a spot beam (e.g., to indicate that the beam energy is focused on a specific spot in the spatial direction). For example, as shown in FIG. 10, three spot beams may be applied for WTRU1, WTRU2 and WTRU3, where WTRU1 and WTRU2 may share the same spatial direction. If WTRU1 and WTRU2 are under far field conditions, then a single beam (e.g., only a single beam) may be applied to WTRU1 and WTRU2 because they are in the same spatial direction. Therefore, a WTRU may be informed of whether it is under near filed conditions or far field conditions.

A near field indicator may be provided. A QCL framework may assist a WTRU to set or adjust its receive spatial filter such as a DL Rx beam, which may be considered an Rx parameter. The WTRU may find a suitable spatial filter based on a QCL source RS and may apply the spatial filter to a QCL target RS. The WTRU may operate under the assumption that it is in a far field (e.g., receive a planar wave as in a far field), for example, when the WTRU estimates an Rx parameter such as an AoA from a source Rx. The WTRU may apply the estimated Rx parameter such as the AoA to the reception of a target RS. The far field assumption may be inaccurate if the WTRU is in a near field of the transmit array (e.g., for Rx parameter estimation from a source RS and/or its application to a target Rs), which may result in an inaccurate Rx parameter estimation and/or an inaccurate spatial filter. A proper estimation method for an Rx parameter may be different in the near field than in the far field. A proper parameter estimation in the near field may assume that spherical waves are received at the WTRU antenna array (e.g., rather than a planar wave as in the far field).

The WTRU may take additional Rx parameters (e.g., other than the Rx parameter(s) used in the far field such as an AoA) into account when setting or adjusting the spatial filter for a target RS based on parameter estimation from a source RS. An example additional Rx parameter may be an angular spread that may be estimated from the source RS and applied to the receive spatial filter for the target RS. In the far field, the WTRU may form a narrow Rx beam in the direction of an estimated AoA, while in the near field, the WTRU may form a wider beam (e.g., with a wider angular spread) in the direction of the estimated AoA, for example, to receive more signal energy from the whole transmit array. A TCI state enhancement may be implemented for beamfocusing, for example, to indicate whether a WTRU is in a near field or a far field.

A network may provide an indication to a WTRU regarding whether the WTRU is in a far field or a near field. The indication may be provided with a single bit or multiple bits, and the WTRU may use the indication to adjust its Rx parameter(s) such as a DL received beam for reception of a spot beam or multiple spot beams.

In some examples, the WTRU may use the spatial filter used for a DL reception as a spatial transmission filter for a UL transmission, e.g., if the WTRU supports beam correspondence or if a DL RS is configured as a spatial reference for the UL transmission. If the WTRU sets or adjusts its spatial receive filter based on a near field indicator, and the WTRU uses the spatial receive filter as a spatial transmission filter, the near field indicator may impact (e.g., indirectly) the spatial transmission filter for the UL transmission.

The near field/far field indicator may be indicated in an MAC CE such as an MAC CE that may activate a TCI state. For example, a near field indicator per activated TCI state may be included in the MAC CE or a near filed indicator applicable to multiple (e.g., all) activated TCI states may be included in the MAC CE. The near field indicator may be included in a DCI that may select a TCI state. The near field indicator may be provided as an RRC configuration parameter to the WTRU.

An example scenario where a per-TCI state near field indication may be applicable is when a TCI state is used for a sub-array of a full array (e.g., a TCI state without near field indicated) and/or when a TCI state is used for the full array (e.g., a TCI state with near field indicated).

A WTRU may be in the area of multiple (e.g., two) TRPs with large arrays and the WTRU may be in the near field of a first TRP and the far filed of a second TRP. For signals and channels transmitted from the first TRP, the WTRU may apply the near field assumption, while for signals and channels transmitted from the second TRP, the WTRU may apply the far field assumption. This may be achieved by indicating near field for the TCI states associated with the first TRP while not indicating near field for TCI states associated with the second TRP. If the WTRU is scheduled to receive a signal/channel from the full array of the first TRP (e.g., a PDSCH), the WTRU may use Rx parameter(s) such as a sufficiently wide Rx beam based on the near field assumption. If the WTRU is scheduled to receive a signal/channel from the full array of the second TRP (e.g., a PDSCH), the WTRU may use Rx parameter(s) such as a narrow Rx beam based on the far field assumption.

In some examples, the assumption that a WTRU is in the near filed or in the far field may be applicable to some reference signals such as a PDSCH DM-RS and/or a PDCCH DM-RS. For some reference signals such as a TRS, the WTRU may assume far field regardless the near field indicator.

A TCI state may be associated with a distance parameter (e.g., if a WTRU uses that TCI state). In this case, the WTRU may assume a distance that is associated with the TCI state. A near field indicator may comprise a distance parameter. The distance may be in relation to a Rayleigh distance (R) or an effective Rayleigh distance as described herein. The Rayleigh distance may indicate near or far field conditions in a way that may not require the WTRU to know TRP array (or sub-array) dimensions. In examples where a binary near field indicator (e.g., a distance parameter) is used, a first indicator value may correspond to a distance larger than (or equal to) the Rayleigh distance R, and a second indicator value may correspond to a distance smaller than (or equal to) the Rayleigh distance R. In examples where a 2-bit near field indicator (e.g., a distance parameter) is used, a first value may correspond to a distance larger than the Rayleigh distance R, a second value may correspond to a distance between ε₁R and R, a third value may correspond to a distance between ε₂R and ε₁R, and a fourth value may correspond to a distance between ε₃R and ε₂R, with

$$0 \leq {ε}_{3} < {ε}_{2} < {ε}_{1} < 1 ( e . g . , {ε}_{3} = 0 , {ε}_{2} = \frac{1}{3} , {ε}_{1} = \frac{2}{3} ) .$$

The value of εᵢ may be based on a pre-defined value or based on RRC configuration information. The value of εᵢ may be updated, for example, by a MAC CE. In some examples, the distance parameter may be an actual distance between the WTRU and an array (e.g., the center of the array), for example, in units of meters.

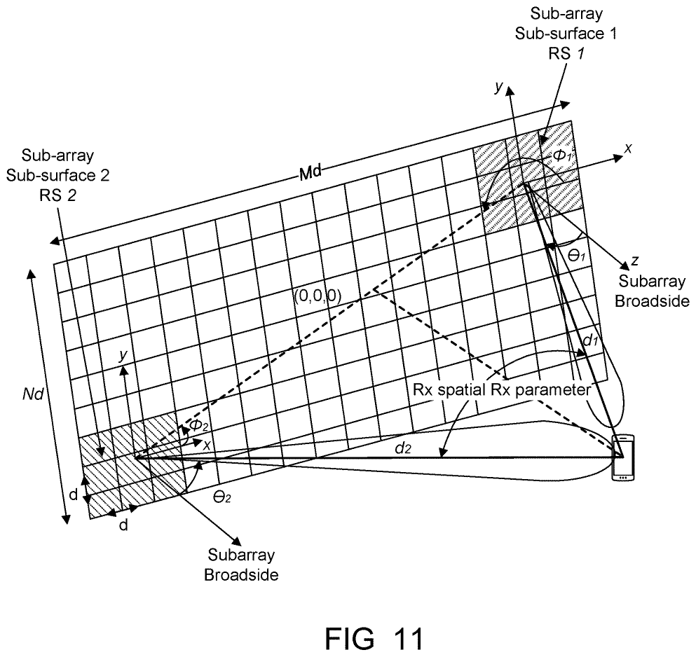

Bundled CSI-RS may be used to indicate to a WTRU that a (e.g., each) CSI-RS in the bundle may be associated with a sub-array in a large array (e.g., of a TRP), for example, as shown in FIG. 11. In this way, the WTRU may determine that certain configured CSI-RSs may be from the same array (e.g., of a TRP). Based on this determination, the WTRU may utilize correlated information such as an AoA, AoD, and/or path delay of sub-arrays from the same array. In examples, the large array may be formed based on multiple panels associated with the TRP and some CSI-RSs may be bundled to indicate that those CSI-RSs may be associated with panels or sub-panels from the same TRP.

The WTRU may estimate a bundle of multiple Rx parameters (e.g., multiple AoAs) from a bundle of multiple RS, and may use the bundle of Rx parameters to determine a spatial receive filter for a target RS (e.g., PDSCH DMRS). For example, the WTRU may estimate Q (e.g., two) AoAs from a bundle of Q (e.g., two) CSI-RSs. The Q (e.g., two) CSI-RSs may be transmitted from Q sub-arrays in the up-right and bottom-left corners of the array, as shown in FIG. 11 (e.g., the bundle of Q) estimated AoAs may span the angular spread of signals received from the full array). The WTRU may use the bundle of AoAs to determine a spatial receive filter for a target RS. For example, the WTRU Rx beam corresponding to the spatial receive filter may be wide enough to receive signals between the bundle of angles with sufficient gains. For instance, if the Q (e.g., two) AoAs are (+10 degrees horizontal, +20 degrees vertical) and (−10 degrees horizontal, −20 degrees vertical), then the corresponding WTRU Rx beam (e.g., beam width) may be such that it may provide gains between −10 and +10 degrees in the horizontal angle and gains between −20 and +20 degrees in the vertical angle.

The network (e.g., a base station) may indicate to the WTRU that it may use a bundle of RSs to determine a spatial Rx parameter for a target RS. For example, the WTRU may use a near field assumption when determining a spatial receive filter (e.g., if the network activates or indicates multiple RSs as QCL source RSs (e.g., of QCL type D) for a target RS such as a PDSCH DMRS). In some examples, the WTRU may be configured to use the near field assumption if multiple RSs are activated (or applicable) as QCL sources (e.g., type D) for a target RS. If not configured to use the near field assumption, the WTRU may use legacy behavior when multiple RSs are activated as QCL sources (e.g., apply different QCL assumptions to different target RS antenna ports, etc.). In some examples, a MAC CE (e.g., a MAC CE used to activate TCI states, which may include QCL source RSs) may be used to indicate to the WTRU that it may use a near field assumption if multiple RSs are activated or indicated for a target RS.

The WTRU may be configured with CSI-RS bundling. For example, the WTRU may treat a set of CSI-RSs in a set of TCI states (e.g., source RSs) applicable to PDCCH/PDSCH reception as a CSI-RS bundle. A TCI state may be applicable to PDCCH/PDSCH reception, for example, if the TCI state has been activated by a MAC CE and/or if it has been indicated in a DCI (e.g., the TCI state is associated with an indicated TCI code point). The bundling may be achieved using the MAC CE, for example, by mapping the TCI states that include the CSI-RS to the same TCI codepoint.

A TCI state configuration may include a CSI-RS bundle (e.g., a set of CSI-RSs). For example, an enhanced TCI state configuration may include multiple CSI-RS resource IDs with applicability to a spatial Rx parameter. If such a TCI state is applicable to PDSCH reception, a WTRU may use the set of CSI-RSs in the TCI state as a CSI-RS bundle.

A WTRU may be configured with or informed that a CSI-RS bundle may be used to derive an Rx parameter for a DL transmission (e.g., PDSCH). This may be accomplished through CSI-RS bundle in (or associated with) an activated TCI state(s) for PDSCH, through association between a PDSCH and a CSI report group, etc. For example, the WTRU may receive a CSI-RS bundle with a narrow beam/far field assumption and may estimate a bundle of Rx parameters (e.g., two AoAs) to determine the Rx parameter for reception. This way, the WTRU may receive a PDSCH transmission with a wide WTRU Rx beam that may be based on the bundle of Rx parameters (e.g., two AoAs).

A CSI report group may be associated with bundled CSI-RSs. A (e.g., each) CSI-RS report in a CSI report group may be configured with a CSI-RS resource set and a configured CSI-RS resource in the CSI-RS resource set may be bundled with other CSI-RS resources associated with a different CSI-RS report. A WTRU may determine, based on the bundled CSI-RSs, that they may be associated with sub-arrays in a large array of a TRP. The WTRU may determine a CSI report group from the bundled CSI-RSs that may be associated with multiple CSI reports. For instance, the WTRU may be triggered with four CSI reports and there may be four bundled CSI-RSs (e.g., in the same CSI-RS resource set or different CSI-RS resource sets). If each bundled CSI-RSs is associated to a CSI-RS report, then the WTRU may determine that the triggered CSI reports may belong to the same CSI report group. For instance, the WTRU may be triggered with four CSI reports and four bundled CSI-RSs {CSI-RS #1, CSI-RS #2, CSI-RS #3, CSI-RS #4} (e.g., the bundled CSI-RSs may be in the same CSI-RS resource set or different CSI-RS resource sets) may be assigned to the CSI reports (e.g., CSI-RS #1 may be configured for CSI report #1, CSI-RS #2 may be configured for CSI report #2, . . . , CSI-RS #4 may be configured for CSI report #4). Because each bundled CSI-RS in this bundle is associated with a corresponding configured CSI-RS report, the WTRU may determine that the triggered CSI reports are within the same CSI report group.

A group of spot beams may cover a particular range of spatial areas, e.g., as shown in FIG. 10. This may be because a near field beamformed vector (e.g., a beamfocused vector) may use distance information and/or far field angle information (e.g., as shown in Eq. (4)), and a spot beam may focus the beam energy on a specific location. Therefore, the probability of interference among WTRUs may be low.

A WTRU may select the best L1-RSRP or L1-SINR spot beam and may report the selection a base station. The base station may use the selected spot beam(s) for refined distance estimation (e.g., because the beamformed vector may be based on distance information).

Multiple spot beams may be transmitted (e.g., simultaneously) to a WTRU, for example, to avoid losing a beamfocusing spot beam due to WTRU rotation or slow movement. For example, the base station may simultaneously transmit multiple scheduled PDSCH transmission (e.g., with a same payload and/or same time and frequency resources) to the WTRU and each PDSCH may be associated with a spot beam. The WTRU may combine the multiple receptions of the PDSCH (e.g., to enhance an SINR) or select a PDSCH (e.g., the one with the best SINR) for reception. A control channel for multi-TRP (M-TRP) transmission may use different CORESET pools for the M-TRP transmission (e.g., CORESET pool ID=1 for the 1st TRP and CORESET ID=2 for the 2nd TRP). The control channel (e.g., PDCCH) may indicate more than M (e.g., M=4) TCI states for scheduled PDSCHs within a same CORESET pool ID, and each TCI state may be associated a schedule PDSCH. This may be because multiple spot beams may be from the same array, so it may not be necessary to distinguish the CORESET pool IDs. For example, multiple TCI states may be assigned to a PDSCH (e.g., the TCI states may be indicated by DCI) and a WTRU may choose one of the scheduled PDSCH transmissions for reception or may combine multiple PDSCH transmissions.

In examples for near field beamfocusing, a CSI report group may be configured for a WTRU and the CSI report group may include multiple CSI reports. Near field CSI acquisition may be performed based on multiple partial CSIs, where each partial CSI may be associated to a sub-array or sub-surface. The WTRU may perform CSI compression for a (e.g., each) partial CSI report (e.g., report #1, . . . #Q) in the CSI report group. The WTRU may do so, for example, if the report quantity is set to “CSI compression” in the CSI-ReportConfig information element (IE) (or a different IE).

The WTRU may feedback (e.g., report) quantized bits of compressed CSI for each partial CSI report #1, . . . #Q to a base station or the WTRU may feedback quantized bits of jointly compressed CSIs to the base station, e.g., based on a joint-compression indication. The WTRU may feedback ToA and/or TDoA information based on a (e.g., each) CSI-RS configured in a (e.g., each) CS report for assistance information. The base station (or another network device) may request the WTRU to transmit an SRS to assist with DL CSI acquisition. The base station may schedule an SRS transmission or multiple SRS transmissions.

In examples, a near field indicator may be signaled to the WTRU to inform the WTRU whether it is in a near field to perform spot beam reception. The near field indicator may be indicated in an MAC CE, DCI, or RRC configuration parameter.

Bundled CSI-RS may be used for deriving Rx parameter(s) for near field DL reception. Bundled CSI-RS may be applied to a CSI report group to indicate that CSI-RSs in the bundle are from sub-arrays of a large array. Multiple PDSCH transmissions may be simultaneously scheduled for a WTRU and each scheduled PDSCH may be associated with a spot beam from the same array. Multiple DCI for the scheduled PDSCH transmissions may be within the same COREST pool.

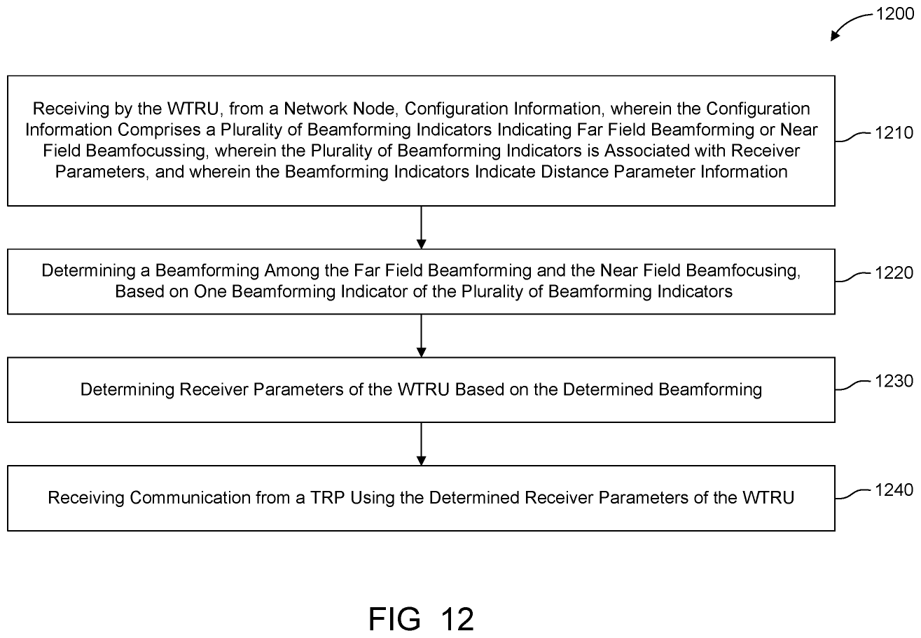

Referring to FIG. 12, a method 1200, implemented in a wireless transmit/receive unit, WTRU, for supporting near field operations, may comprise a step of receiving 1210, by the WTRU, from a network node, configuration information, wherein the configuration information comprises a plurality of beamforming indicators indicating far field beamforming or near field beamfocusing, wherein the plurality of beamforming indicators is associated with receiver parameters, and wherein the beamforming indicators indicate distance parameter information. The method 1200 may further comprise a step of determining 1220 a beamforming among the far field beamforming and the near field beamfocusing, based on one beamforming indicator of the plurality of beamforming indicators. The method 1200 may further comprise a step of determining 1230 receiver parameters of the WTRU based on the determined beamforming; and a step of receiving 1240 communication from a transmission/reception point TRP using the determined receiver parameters of the WTRU.

The method 1200 may comprise a step of transmitting communication to the TRP using the determined receiver parameters of the WTRU. The determined receiver parameters may comprise angular spread of the beamforming. The method 1200 may determine far field beamforming on condition that the distance parameter exceeds a distance threshold. The method 1200 may determine near field beamfocusing on condition that the distance parameter does not exceed a distance threshold. One beamforming indicator may comprise information on Rayleigh distance, such that the method 1200 may comprise a step of determining the distance threshold based on the Rayleigh distance; and a step of determining near field beamfocusing on condition that the distance parameter does not exceed the distance threshold. The distance threshold may have been received from the TRP. An information indicating the one beamforming indicator may be comprised in a received DCI. An information indicating the one beamforming indicator may be received in a MAC CE. An information indicating the one beamforming indicator of the plurality of beamforming indicators may be received from the TRP

In an embodiment, a WTRU, comprising a processor, a transceiver unit and a storage unit, may be configured to receive, from a network node, configuration information, wherein the configuration information comprises a plurality of beamforming indicators indicating far field beamforming or near field beamfocusing, wherein the plurality of beamforming indicators is associated with receiver parameters, and wherein the beamforming indicators indicate distance parameter information. The WTRU may be configured to determine a beamforming among the far field beamforming and the near field beamfocusing; based on one beamforming indicator of the plurality of beamforming indicators. The WTRU may be configured to determine receiver parameters of the WTRU based on the determined beamforming; and configured to receive communication from a transmission/reception point TRP using the determined receiver parameters of the WTRU. The WTRU may be configured to transmit communication to the TRP using the determined receiver parameters of the WTRU.

The determined receiver parameters may comprise angular spread of the beamforming. The WTRU may be configured to determine far field beamforming on condition that the distance parameter exceeds a distance threshold. The WTRU may be configured to determine near field beamfocusing on condition that the distance parameter does not exceed a distance threshold. The WTRU, wherein the one beamforming indicator comprises information on Rayleigh distance, may be configured to determine the distance threshold based on the Rayleigh distance; and configured to determine near field beamfocusing on condition that the distance parameter does not exceed the distance threshold. The WTRU may be configured to receive from the TRP the distance threshold. The WTRU may be configured to receive downlink control information comprising an indication of the one beamforming indicator. The WTRU may be configured to receive an indication of the one beamforming indicator in a Medium Access Control (MAC) control element. The WTRU may be configured to receive from the TRP, the one beamforming indicator of the plurality of beamforming indicators.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method implemented in a wireless transmit/receive unit (WTRU) the method comprising:
receiving by the WTRU, from a network node, a first message comprising configuration information indicating a plurality of reference signals associated with a plurality of parts of an antenna array of the network node, and a plurality of beamforming indicators indicating far field beamforming or near field beamfocusing;
receiving one or more downlink reference signals (DL-RSs) of the plurality of reference signals, wherein the one or more DL-RSs are associated with respectively one or more parts of the antenna array of the plurality of parts of the antenna array;
based on the received one or more DL-RSs, determining a channel state information (CSI) report associated with the one or more parts of the antenna array;
transmitting, to the network node, a second message comprising the CSI report;
responsive to transmitting the second message, receiving first information indicating one beamforming indicator of the plurality of beamforming indicators;
determining a beamforming among the far field beamforming and the near field beamfocusing, based on the indicated beamforming indicator;
determining receiver parameters of the WTRU based on the determined beamforming; and
receiving communication from a transmission/reception point (TRP) using the determined receiver parameters of the WTRU.

2. The method of claim 1, wherein the determined receiver parameters comprise angular spread of the beamforming.

3. The method of claim 1 comprising transmitting communication to the TRP using the determined receiver parameters of the WTRU.

4. (canceled)

5. The method of claim 21, wherein determining near field beamfocusing on condition that the distance parameter does not exceed a distance threshold.

6. The method of claim 5, wherein the one beamforming indicator comprises second information on Rayleigh distance, and comprising:
determining the distance threshold based on the Rayleigh distance; and
determining near field beamfocusing on condition that the distance parameter does not exceed the distance threshold.

7. The method of claim 5, comprising receiving, from the TRP, the distance threshold.

8. The method of claim 1, comprising receiving the first information in a downlink control information.

9. The method of claim 1, comprising receiving the first information in a Medium Access Control (MAC) control element.

10. The method of claim 1, comprising receiving from the TRP, the first information.

11. A wireless transmit/receive unit (WTRU) comprising a processor, a transceiver unit and a storage unit, and configured to:
receive, from a network node, a first message comprising configuration information indicating a plurality of reference signals associated with a plurality of parts of an antenna array of the network node, and a plurality of beamforming indicators indicating far field beamforming or near field beamfocusing;
receiving one or more downlink reference signals (DL-RSs) of the plurality of reference signals, wherein the one or more DL-RSs are associated with respectively one or more parts of the antenna array of the plurality of parts of the antenna array;
based on the received one or more DL-RSs, determining a channel state information (CSI) report associated with the one or more parts of the antenna array;
transmitting, to the network node, a second message comprising the CSI report;
responsive to transmitting the second message, receiving first information indicating one beamforming indicator of the plurality of beamforming indicators;
determine, a beamforming among the far field beamforming and the near field beamfocusing, based on the indicated beamforming indicator;
determine receiver parameters of the WTRU based on the determined beamforming; and
receive communication from a transmission/reception point (TRP) using the determined receiver parameters of the WTRU.

12. The WTRU of claim 11, wherein the determined receiver parameters comprise angular spread of the beamforming.

13. The WTRU of claim 11, configured to transmit communication to the TRP using the determined receiver parameters of the WTRU.

14. (canceled)

15. The WTRU of claim 22, configured to determine near field beamfocusing on condition that the distance parameter does not exceed a distance threshold.

16. The WTRU of claim 15, wherein the one beamforming indicator comprises second information on Rayleigh distance, and configured to:
determine the distance threshold based on the Rayleigh distance; and
determine near field beamfocusing on condition that the distance parameter does not exceed the distance threshold.

17. The WTRU of claim 15, configured to receive, from the TRP, the distance threshold.

18. The WTRU of claim 11, configured to receive the first information in a downlink control information.

19. The WTRU of claim 11, configured to receive the first information in a Medium Access Control (MAC) control element.

20. The WTRU of claim 11, configured to receive from the TRP, the first information.

21. The method of claim 1, wherein the indicated beamforming indicator indicates distance parameter information.

22. The WTRU of claim 11, wherein the indicated beamforming indicator indicates distance parameter information.
